(19) United States
(12) Patent Application Publication
(10) Pub. No.: US 2011/0141184 A1
(43) Pub. Date: Jun. 16, 2011

(54) Dot Omission Inspection Method Used in Printing Apparatus and the Printing Apparatus

(75) Inventor: Seiji Izuo, Nagano-ken (JP)

(73) Assignee: SEIKO EPSON CORPORATION, Tokyo (JP)

(21) Appl. No.: 12/962,299

(22) Filed: Dec. 7, 2010

(30) Foreign Application Priority Data
Dec. 11, 2009 (JP) 2009-281939

(51) Int. Cl. B41J 29/393

(52) U.S. Cl. 347/19

(57) ABSTRACT

Provided is a dot omission inspection method used in a printing apparatus for forming an image constituted by dots of photo-curable ink. A normal print process including performing liquid droplet discharge of causing a liquid droplet of the photo-curable ink to be landed on a medium, performing provisional curing of irradiating the liquid droplet landed on the medium using light from a first light source to be provisionally cured thereby suppressing flowing of the liquid droplet, and performing main curing of irradiating a liquid droplet provisionally cured using light from a second light source to be fixed on the medium, and an inspection print process including performing the main curing after the liquid droplet of the photo-curable ink landed on the medium by the liquid droplet discharge is not subjected to the provisional curing and is flowed on the medium to increase the surface area of the liquid droplet, are selectively performed.

### CROSS REFERENCE TO RELATED APPLICATION

Japanese Patent Application No. 2009-281939 is hereby incorporated by reference in its entirety.

### BACKGROUND

1. Technical Field

The present invention relates to a method of inspecting for the omission of a dot to be formed by ink landing on a medium in a printing apparatus such as an ink jet printer for intermittently discharging the ink onto the medium to cause the ink to land at target positions on the medium, and a printing apparatus for forming dots on a medium using the inspection method.

2. Related Art

As a printing apparatus, an ink jet printer for performing printing by intermittently discharging ink onto various types of media such as paper, fabric, or film is known. The ink jet printer forms an image by depositing fine dots formed of ink droplets on the medium. With regard to a configuration or printing operation of the ink jet printer, for example, the medium is moved in a particular transport direction and simultaneously, an ink discharge head having nozzles for discharging ink is reciprocated in a scanning direction intersecting the transport direction. Accordingly, ink droplets discharged from the nozzles land at target positions on the surface of the medium. In addition, the landing ink droplets are formed as dots to constitute an image.

Otherwise, there is a so-called line printer which has a head in which nozzles are fixed in lines or in a zigzag form in the scanning direction over the width of the medium and forms an image by discharging ink while moving the medium in the transport direction.

Moreover, ink is charged in an ink tank, is led by a pump from the ink tank into a space called a reservoir inside the head, and is then guided from the reservoir to a pressure chamber connected to the nozzle. In addition, the pressure chamber is expanded or contracted to discharge the ink from the nozzle.

However, in the ink jet printer, there may be a case where the nozzles clog due to ink sticking and thus ink is not suitably discharged. In addition, there may be a case where the mechanism for discharging ink is malfunctions and thus ink is not suitably discharged. In these cases, liquid droplets of the ink are not landed on the medium and a so-called “dot omission error” occurs. Therefore, in an ink jet printer, the existence of such a dot omission error needs to be inspected for. In this inspection, for example, dots are formed into a predetermined pattern on a medium and the dots are optically analyzed. The optical inspection may be performed on the predetermined pattern (test pattern) of the dots using an optical sensor or an image recognition technique, or may be performed by checking the test pattern with the naked eye. In either case, ink is actually discharged onto the medium for the inspection.

Hitherto, for the ink jet printers, various methods of inspecting whether or not there is a dot omission error by actually performing printing on a recording sheet have been proposed. For example, in a method disclosed in JP-A-2005-35042, an image sensor is provided in the printer, and the printing state is detected using the image sensor to check for the existence of a dot omission. When the dot omission exists, a position of the dot omission is stored to be compensated for by another nozzle or the like during printing. In any case, there is a method of printing a predetermined pattern or the like as an inspection image and optically inspecting for a dot omission the inspection image using an optical instrument or with the naked eye.

In recent ink jet printers, in order to print an image with high precision, the size of dots forming an image has been extremely reduced. In addition, there are various types of ink jet printers depending on the characteristics or kinds of the ink used, methods of fixing ink droplets on a medium, and the like. It is determined that in certain types of printers, there are several cases where it is difficult to magnify fine dots so as to be optically detected.

### SUMMARY

According to an aspect of the invention, there is provided a dot omission inspection method of inspecting for the existence of an omission of a dot, used in a printing apparatus which discharges a photo-curable ink from a nozzle to be landed on a medium as a liquid droplet and irradiates the landed liquid droplets with light to be cured so as to form an image constituted by fine dots on the medium, wherein the printing apparatus selectively performs, as a process of forming the image, a normal print process of forming an arbitrary image and an inspection print process of forming an inspection image as a detection object for a dot omission, wherein the normal print process includes: performing liquid droplet discharge of causing the liquid droplet of the photo-curable ink to be landed on the medium; performing provisional curing of irradiating the liquid droplet landed on the medium using light from a first light source to provisionally cure the liquid droplet so as to suppress flowing of the liquid droplet; and performing main curing of irradiating the provisionally cured liquid droplet using light from a second light source to cure the provisionally cured liquid droplet so as to be fixed on the medium, and wherein, in the inspection print process, the liquid droplet of the photo-curable ink landed on the medium by the liquid droplet discharge is not subjected to the provisional curing and is flowed on the medium so as to increase a surface area of the liquid droplet, and thereafter the main curing is performed.

Further features of the invention will become apparent from the following description of the specification and the accompanying drawings.

### BRIEF DESCRIPTION OF THE DRAWINGS

The invention will be described with reference to the accompanying drawings, wherein like numbers reference like elements.

FIG. 1 is a block diagram illustrating the entire configuration of a printer according to a first embodiment of the invention.

FIG. 2A is a partially cutaway perspective view of the entire configuration of the printer according to the first embodiment, and FIG. 2B is a transverse cross-sectional view of the entire configuration of the printer.

FIG. 3 is an explanatory view illustrating an array of nozzles included in the printer according to the first embodiment.

FIGS. 4A to 4E are diagrams schematically illustrating operations of the printer according to the first embodiment during a normal print mode.

FIGS. 5A to 5E are diagrams schematically illustrating operations of the printer according to the first embodiment during an inspection print mode.

FIG. 6 is a block diagram illustrating the entire configuration of a printer according to a second embodiment of the invention.

FIG. 7A is a partially cutaway perspective view of the entire configuration of the printer according to the second embodiment, and FIG. 7B is a transverse cross-sectional view of the entire configuration of the printer.

FIG. 8 is an explanatory view illustrating an array of nozzles included in the printer according to the second embodiment.

FIGS. 9A to 9D are diagrams schematically illustrating operations of the printer according to the second embodiment during the normal print mode.

FIGS. 10A to 10D are diagrams schematically illustrating operations of the printer according to the second embodiment during the inspection print mode.

### DESCRIPTION OF EXEMPLARY EMBODIMENTS

### Embodiments and Examples of the Invention

There is a type of printing apparatus in which photo-curable ink that is cured by ultraviolet rays or visible light is used. In this type of printing apparatus, ink landed on a medium is irradiated with light to cure a liquid droplet of the ink so as to be fixed on the medium. In addition, as the printing apparatus using the photo-curable ink, there is a type of printing apparatus in which the liquid droplet of the ink landed is immediately irradiated with light having a low energy compared to light irradiation for fixing in order to prevent the liquid droplet from flowing, so as to cure a surface of the liquid droplet of the ink, that is, so-called “provisional curing” is performed. As described above, in the printer having a function of the provisional curing, as a liquid droplet of ink of a certain color is landed on a medium, the liquid droplet is provisionally cured, so that there is no situation in which the ink flows on the medium and the surface area of the liquid droplet is increased. Accordingly, when the size of the liquid droplet is small, it becomes more difficult to form a dot large enough to be optically detected. Of course, a scanner with high precision may be used for the optical detection. However, in this case, the inspection cost is increased, resulting in an increase in manufacturing costs of the printing apparatus.

Therefore, according to an embodiment of the invention, a printing apparatus having the provisional curing function described above is provided, and a method of performing the optical dot omission inspection at low cost in the printing apparatus is an example of the invention. In addition, the example of the invention has the following features as well as the main features of the invention described above.

Plural kinds of ink of different colors exist as the ink, the colors include relatively light colors and deep colors, and in the inspection print process, with regard to the time to start main curing after the liquid ink droplet is landed on the medium by the liquid droplet discharge, the time for the liquid droplet of the ink of light colors is longer than that of the liquid droplet of the ink of deep colors.

In addition, the printing apparatus according to the embodiment of the invention is a printing apparatus for forming an image by causing a liquid droplet to be landed on a medium, including: a plurality of nozzles for discharging a photo-curable ink as liquid droplets; a provisional curing irradiating unit; a main curing irradiating unit; and a control unit, wherein the provisional curing irradiating unit irradiates the liquid droplets landed on the medium with light to provisionally cure the liquid droplet to prevent the liquid droplet from flowing, wherein the main curing irradiating unit irradiates the liquid droplet landed on the medium with light to cure the liquid droplet so as to be fixed on the medium, wherein the control unit selectively performs a normal print process of forming an arbitrary image and an inspection print process of forming an inspection image as a detection object for a dot omission, wherein the normal print process includes: performing liquid droplet discharge of causing liquid droplets of the photo-curable ink to be landed on the medium; performing provisional curing of irradiating the liquid droplet landed on the medium using light from the provisional curing irradiating unit to provisionally cure the liquid droplet so as to suppress flowing of the liquid droplet; and performing main curing of irradiating the provisionally cured liquid droplet using light from the main curing irradiating unit to cure the provisionally cured liquid droplet so as to be fixed on the medium, and wherein, in the inspection print process, the liquid droplet of the photo-curable ink landed on the medium by the liquid droplet discharge is not subjected to the provisional curing and is flowed on the medium so as to increase a surface area of the liquid droplet, and thereafter the main curing is performed.

The printing apparatus further includes first and second heads provided with a plurality of the nozzles arranged in a direction perpendicular to a transport direction in which the medium is supplied from an upstream side and the medium is discharged to a downstream side over a width of the medium, wherein the provisional curing irradiating unit includes a first provisional curing irradiating unit and a second provisional curing irradiating unit, the nozzles are provided to respectively correspond to the plurality of kinds of the ink including the relatively light colors and deep colors, the first and second heads, the first and second provisional curing irradiating units, and the main curing irradiating unit are disposed in the order of the first head, the first provisional curing irradiating unit, the second head, the second provisional curing irradiating unit, and the main curing irradiating unit from the upstream side to the downstream side of the transport direction, and the control unit discharges the ink of light colors from the nozzle of the first head in the inspection print process.

### First Embodiment

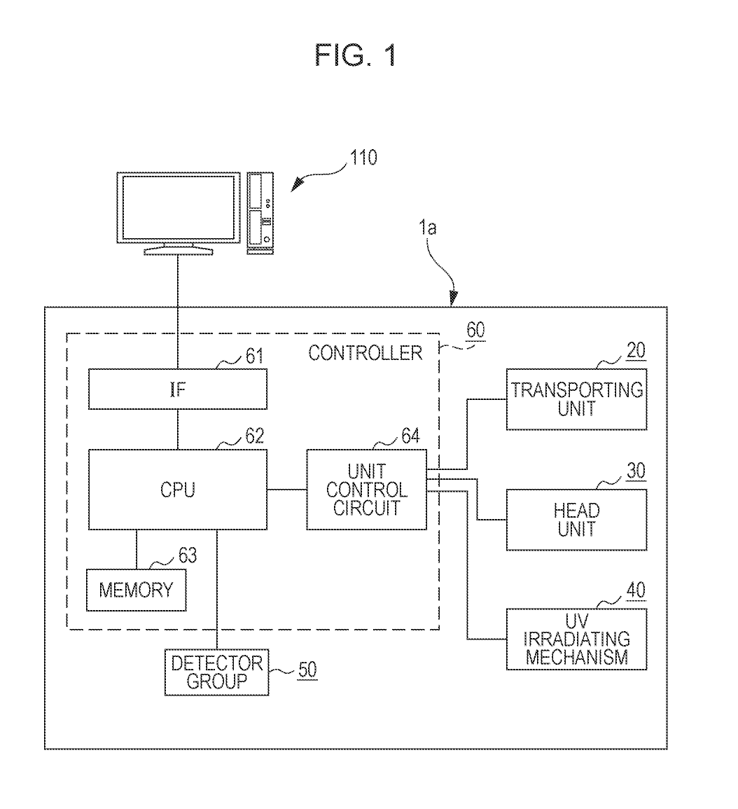

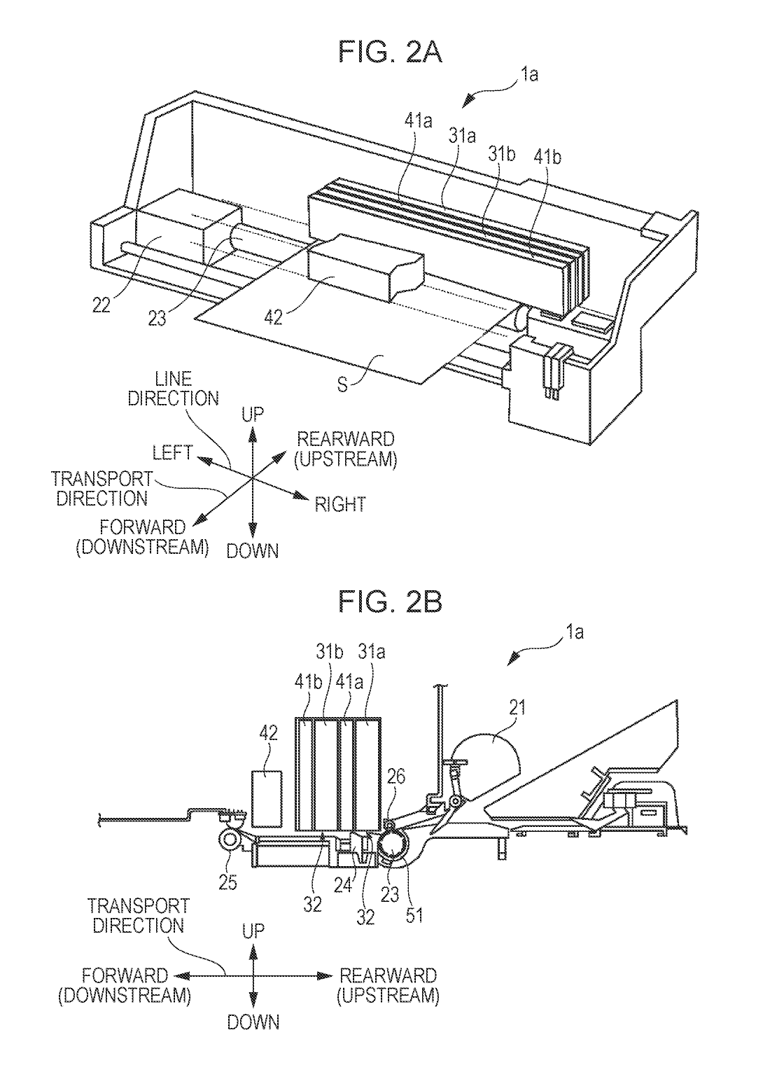

As a first embodiment for implementing a dot omission inspection method which is an example of the invention, an ink jet printer (hereinafter, referred to as a printer) which uses ink (UV ink) that is cured by ultraviolet rays (UV) is exemplified. FIG. 1 is a block diagram of the entire configuration of a printer 1a. In FIGS. 2A and 2B, a schematic structure of the printer 1a is illustrated. FIG. 2A is a cutaway perspective view of the printer 1a, and FIG. 2B is a transverse cross-sectional view of the printer 1a. The printer 1a illustrated is a line printer in which a head extends in a width direction (hereinafter, referred to as a line direction) of a medium and mainly includes a transporting unit 20, a head unit 30, a detector group 50, a controller 60, and a LTV irradiating mechanism 40.

The controller 60 is a control unit for controlling the printer, and includes a CPU 62 which is a processing unit, a memory 63 which is configured as a memory element such as a RAM or an EEPROM and in which a storage area for programs executed by the CPU 62 and a work area for the programs are ensured, a unit control unit 64 for driving the units 20, 30, and 40, an interface unit (IF) 61 for receiving and transmitting data between the printer 1a and a computer 110 which is an external apparatus, and the like.

The detector group 50 includes various sensors for detecting various statuses in the printer 1a, and each sensor included in the detector group 50 outputs the detection result (detection data) to the controller 60. Moreover, in the detector group 50, for example, a rotary encoder 51 for detecting the amount of rotation of a transporting roller 23, and the like are included.

The transporting unit 20 transports a medium S such as paper in a predetermined direction (hereinafter, referred to as a transport direction). The transporting unit 20 includes a feeding roller 21, a transporting motor 22, the transporting roller 23, a platen 24, and a discharging roller 25 as main components. The feeding roller 21 is a roller for feeding the medium S inserted into an insertion port for a medium S into the printer 1a. In addition, the above-mentioned transporting roller 23 is a roller for pinching the medium S with a driven roller 26 and for transporting the medium S fed by the feeding roller 21 to an area where printing can be performed and is driven by the transporting motor 22. The controller 60 detects the amount of movement of the medium S on the basis of the amount of rotation of the transporting roller 23.

The platen 24 supports the medium S during printing. The discharging roller 25 is a roller which is provided on the downstream side of the transport direction with respect to the area where printing can be performed and pinches the medium S with the driven roller 27 to discharge the medium S to the outside of the printer 1a. The discharging roller 25 rotates in synchronization with the transporting roller 23. Moreover, the transporting roller 23 and the discharging roller 25 are designed so that their circumferences are each 1 inch and thus the amount of transport per rotation is 1 inch.

The head unit 30 has a configuration for discharging ink toward the medium and includes, as well as heads 31a and 31b having nozzles, an ink tank, a pump for supplying ink to the heads from the ink tank, and the like. In this embodiment, ink of a plurality of different colors for performing multi-color printing is charged in the individual ink tanks.

In this embodiment, the UV irradiating mechanism 40 includes provisional curing irradiating units 41a and 41b for performing provisional curing and a main curing irradiating unit 42 for irradiating UV to finally fix the UV ink onto the medium S, and simultaneously, as illustrated in FIG. 2B, has a pair of the heads 31a and 31b and a pair of the provisional curing irradiating units 41a and 41b so that the heads 31a and 31b and the provisional curing irradiating units 41a and 41b are alternately disposed along the transport direction of the medium S.

### Basic Operations of Printer

The CPU 62 in the controller 60 processes print data received from the computer 110 via the IF 61, detection data received from the detector group 50, or the like by executing the programs stored in the memory 63 and controls the units 20, 30, and 40 through the unit control circuit 64 on the basis of the processing results, thereby forming a printed image on the medium S.

The printer 1a forms the printed image with dots of color ink on the medium S thereby printing an image. The head unit 30 has a configuration for discharging the ink droplets toward the medium S. A lower surface 32 of the head unit 30 is provided with a plurality of nozzles which are opened.

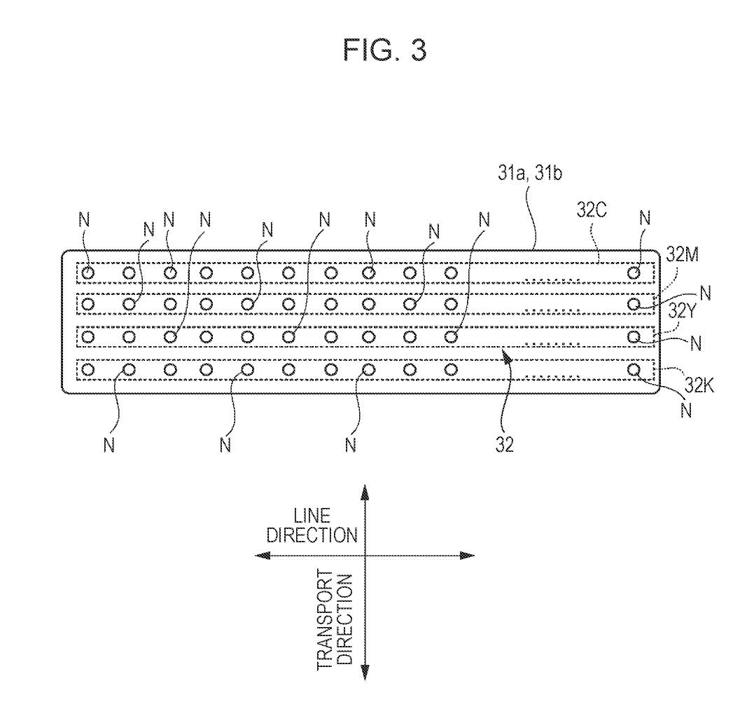

FIG. 3 illustrates an array of the nozzles N. In the lower surface 32 of the heads 31a and 31b, the plurality of the nozzles N are lined and opened at predetermined intervals in the line direction to form nozzle rows 33K, 33C, 33M, and 33Y. The nozzle rows 33K, 33C, 33M, and 33Y are lined at predetermined intervals along the transport direction, and the nozzle rows 33K, 33C, 33M, and 33Y respectively correspond to inks with different colors. In this example, the black ink nozzle row 33K, the cyan ink nozzle row 33C, the magenta ink nozzle row 33M, and the yellow ink nozzle row 33Y are formed.

Each nozzle N is provided with an ink chamber (not shown) and a piezo element. An ink droplet is discharged from the nozzle N as the ink chamber is expanded and contracted by driving the piezo element. In addition, as the heads 31a and 31b having the above-described configuration intermittently discharge ink droplets during transporting of the medium S, dots formed of the ink droplets on the medium S are two-dimensionally disposed on the medium S, thereby forming an image.

### UV Irradiating Mechanism

In this embodiment, by irradiating the liquid droplet of the UV ink landed on the medium S with UV, the liquid droplet (UV ink droplet) is cured as a dot for constituting an image. The UV irradiating mechanism 40 includes a UV light source, a drive circuit for turning the light source on and off, and the like. As described above, the printer 1a includes the provisional curing irradiating units 41a and 41b for irradiating the UV ink droplets landed on the medium S with UV for performing the provisional curing and the main curing irradiating unit 42 for performing UV irradiation to fully cure the UV ink droplets. In addition, an ultraviolet LED or the like may be used as the light source for the provisional curing irradiating units 41a and 41b, and a metal halide lamp or the like may be used as the light source for the main curing irradiating unit 42.

Here, assuming that the line direction is a left and right direction and the direction in which the medium S is discharged in the transport direction is defined as forward or downstream, as illustrated in FIGS. 2A and 2B, when the left and the right of the line direction are defined as viewed from the front of the printer 1a, the two heads 31a and 31b and the two provisional curing irradiating units 41a and 41b are alternately disposed from the upstream side toward the downstream side so that the first head (upstream side head) 31a is disposed on the most upstream side and the first provisional curing irradiating unit (first provisional curing irradiating unit) 41a, the downstream side head 31b, and the second provisional curing irradiating unit 41b are sequentially disposed toward the downstream side.

In addition, the UV irradiation operations are performed by the provisional curing irradiating units 41a and 41b so that ink droplets discharged from the upstream side head 31a and landed on the medium S are provisionally cured by the light irradiated by the first provisional curing irradiating unit 41a and ink droplets discharged from the downstream side head 31b onto the medium S are provisionally cured by the light irradiated by the second provisional curing irradiating unit 41b. That is, in this embodiment, provisional curing is performed, when UV ink is discharged from the heads 31a and 31b during transporting of the medium S and UV ink droplets are landed on the medium S, by irradiating the LTV ink droplets with low energy UV. In addition, with regard to the light source for the provisional curing irradiating units 41a and 41b, the same number of LEDs as that of the nozzles N included in the nozzle rows 33K, 33C, 33M, and 33Y are disposed at the same pitch and at substantially the same positions as those of the nozzles along the line direction.

On the other hand, the main curing irradiating unit 42 is provided further on the downstream side in the transport direction with respect to the downstream side head 31b to extend in the line direction. The LTV irradiation range thereof is longer than the width of the medium S to be printed. In addition, the main curing irradiating unit 42 irradiates the medium S with UV when the medium S moves in the transport direction. Accordingly, the UV ink droplets that are provisionally cured on the medium S are fully cured.

### Dot Omission Inspection Method

In the printer 1a having the above-described configuration as the example of the invention, a method of performing an optical dot omission inspection is exemplified. The controller 60 controls the units 10, 20, 30, and 40 and switches between a normal print mode in which the printer 1a forms an arbitrary image and an inspection print mode in which predetermined images (inspection images) such as test patterns are printed in a predetermined order to perform the dot omission inspection. Hereinafter, the order of formation of the ink dots in the two print modes will be described as an example of the invention.

### Normal Print Mode

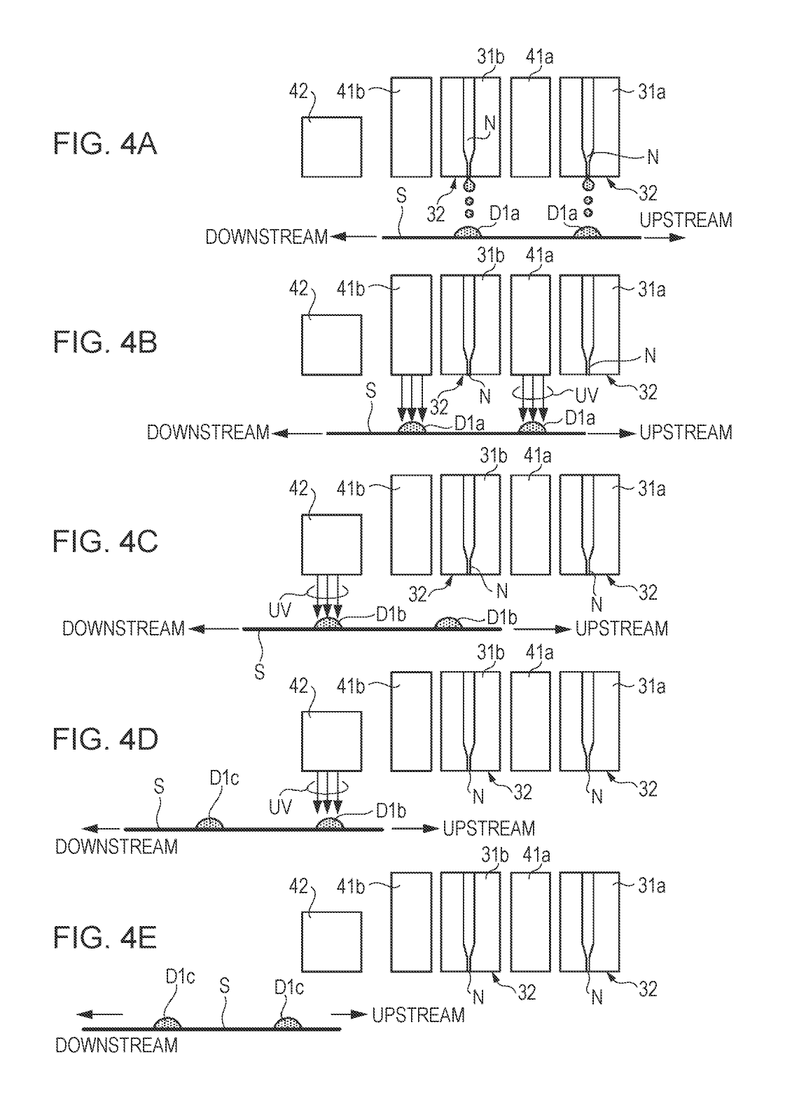

In the normal print mode, for example, operations for printing an arbitrary image such as a document or a still image displayed on a personal computer are performed. An example of the operations of the printing apparatus performed in the normal print mode is illustrated in FIGS. 4A to 4E. Here, the medium S is transported from the upstream side to the downstream side. First, a liquid droplet D1a of ink of a certain color is discharged from one of or both the upstream side head 31a and the downstream side head 31b onto the medium S being transported such that the liquid droplet D1a is landed on the medium S (FIG. 4A). In addition, the liquid droplet D1a of the ink is provisionally cured by the first provisional curing irradiating unit 41a (FIG. 4B). In addition, as the medium S is transported toward the downstream side, a liquid droplet D1b of the color ink provisionally cured is irradiated with UV by the main curing irradiating unit 42 (FIGS. 4C and 4D). Accordingly, a dot D1c of the color ink is fixed on the medium S (FIG. 4E).

### Inspection Print Mode

In the inspection print mode, operations for printing an inspection image dedicated to inspect for a dot omission are performed. As the inspection image, an image formed as a regular pattern in which dots of colors are arranged in line or in a matrix form so as to represent the position of each dot as relative coordinates may be considered. That is, when a correspondence relationship between coordinates and dots on the surface of the medium S is determined in advance, existence of a dot omission can be detected on the basis of whether or not a dot of a predetermined color exists at a predetermined coordinate position when the inspection image is read by an optical instrument such as a scanner.

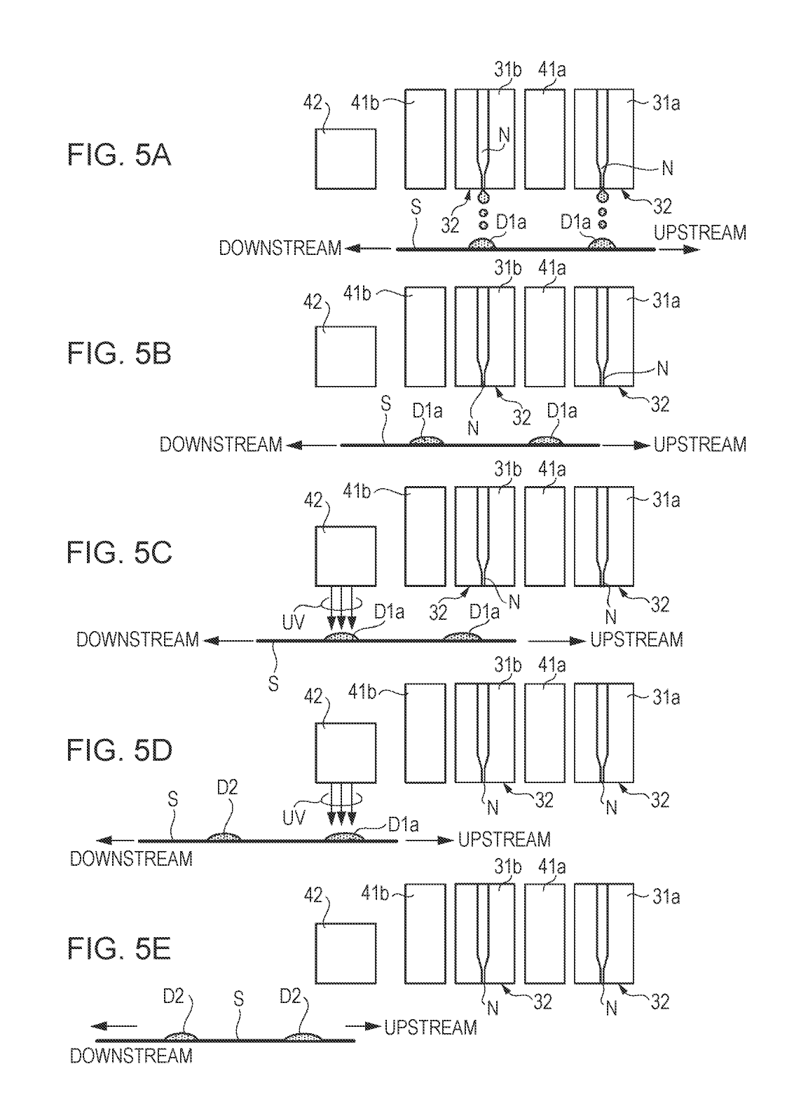

FIGS. 5A to 5E schematically illustrate the operations performed in the inspection print mode. In order to print the inspection image, first, a liquid droplet D1a of ink of a certain color is discharged to be landed on the medium S (FIG. 5A). Then, the liquid droplet D1a of the ink is not subjected to the provisional curing, the medium S is transported to the downstream side as is (FIG. 5B), and the liquid droplet D1a of this color ink is irradiated with UV by the main curing irradiating unit 42 (FIGS. 5C and 5D), thereby fixing a dot D2 of the color inks on the medium S (FIG. 5E).

### Dot Omission Inspection

The inspection image printed in the above-described inspection print mode is read by an optical instrument such as a scanner. Whether or not a color dot to be formed at a certain position exists is detected by analyzing the read image data to determine whether or not a liquid droplet is accurately landed. As the inspection image, a regular pattern in which dots of colors are arranged in line or in a matrix form so as to represent the position of each dot as relative coordinates may be considered. That is, when a correspondence relationship between coordinates and dots on the sheet surface is determined in advance, existence of a dot omission can be detected on the basis of whether or not a dot of a predetermined color exists at a predetermined coordinate position in the inspection image read by the optical instrument such as the scanner.

In addition, in the dot omission inspection method in this example, since the ink droplet D1a landed on the medium S is not provisionally cured, the ink droplet D1a flows on the medium S until the main curing is performed after the medium S is transported, and the surface area of the liquid droplet D1a is increased compared to that formed during the landing. Accordingly, existence of a dot can be easily detected without a high precision scanner.

In this example, the printed inspection image is read by the additional scanner to inspect for the dot omission. However, instead of the external scanner, an imaging device such as a CCD having a large number of pixels may be embedded into the printer 1a. In addition, individual ink droplets D1a landed on the medium S or dots D2 after being subjected to the main curing may be individually detected in conjunction with the printing operation. In the imaging device, for example, each pixel or a predetermined number of the pixels of the imaging device may correspond to a single nozzle N, and simultaneously, the imaging device may be disposed in line on the downstream side of the main curing irradiating unit 42. In addition, existence of the dot D2 may be detected until the medium S is discharged after the ink droplet D1a is fully cured. Otherwise, the imaging device may be provided between the second provisional curing irradiating unit 41b and the main curing irradiating unit 42.

Of course, existence of the dot omission may be detected with the naked eye. Either way, the dot omission inspection method in this example is characterized by the order of forming the inspection image provided for inspecting for a dot omission in the printing apparatus having the provisional curing mechanism.

### Another Example

In recent ink jet printers, very fine dots are formed, and ink of a larger number of colors is used to enrich color expression. In addition, ink having a relatively lighter color than other colors, such as a light yellow, may be used. Moreover, if ink of all colors is discharged in the order illustrated in FIGS. 5A to 5E and fully cured in the same manner to form the dots, it becomes difficult to reliably detect ink having a light color. Otherwise, for reliable detection, a scanner having high resolution and high sensitivity needs to be used. Therefore, selectively increasing the surface area of a liquid droplet of the ink having a light color is to reliably detect the ink droplets is considered. In addition, the detecting technique is exemplified as another example of the invention.

In the another example, the configuration of the printer 1a having the two heads 31a and 31b according to the embodiment is used, and the surface area of the ink droplet of light colors is increased compared to that of ink droplets of other colors. Specifically, in the printer 1a, the two heads 31a and 31b are disposed on upstream and downstream sides in the transport direction of the medium S, respectively, and the ink droplet D1a discharged from the upstream side head 31a and landed on the medium S takes more time to be fully cured than the ink droplet D1a discharged from the downstream side head 31b. That is, it has a longer time to flow. It is more difficult to optically detect a dot of ink of light colors than ink of other deep colors. In addition, using this fact positively, the ink of light colors is allowed to be discharged from the upstream side head 31a. Accordingly, without an expensive scanner with high resolution or high sensitivity, existence of a dot with light colors can be reliably detected, thereby suppressing an increase in inspection costs.

### Inspection Image

In the printer according to the first embodiment, with regard to the ink droplet discharged from the upstream side head 31a and the ink droplet discharged from the downstream side head 31b, when the two ink droplets are fully cured to be finally formed as dots, the dots have different sizes. In addition, since the surface area of the dot of the ink discharged from the upstream side head 31a is increased, there is a possibility that the adjacent dots in the inspection image overlap with each other and thus the dots cannot be individually detected resulting in degradation in the reliability of the dot omission inspection. Therefore, in the inspection print mode, the interval between the dot of the ink discharged from the upstream side head 31a and the adjacent dot may be increased to be greater than the interval between the dots of the ink discharged from the downstream side head 31b to print the inspection image.

### Second Embodiment

The printer 1a according to the first embodiment is a line printer; however, a serial printer may also be employed. Specifically, instead of the configuration in which the head is disposed in the line direction over the width of the medium, a configuration in which the head moves in a direction intersecting the transport direction may be employed. In addition, the printer having this configuration is exemplified as a second embodiment, and hereinafter, a dot omission inspection method used in the printer according to the second embodiment will be described.

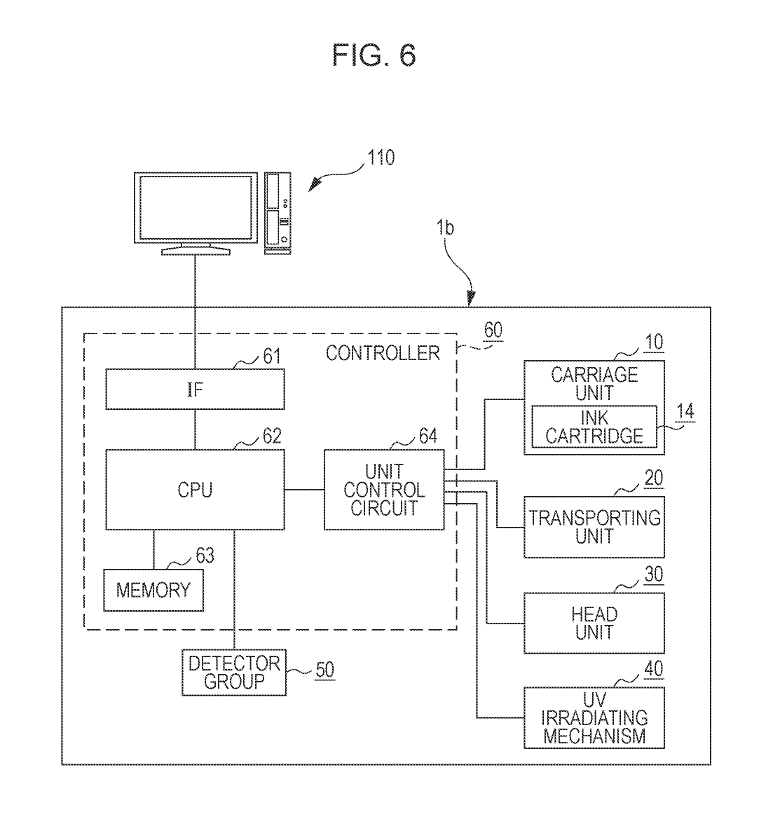

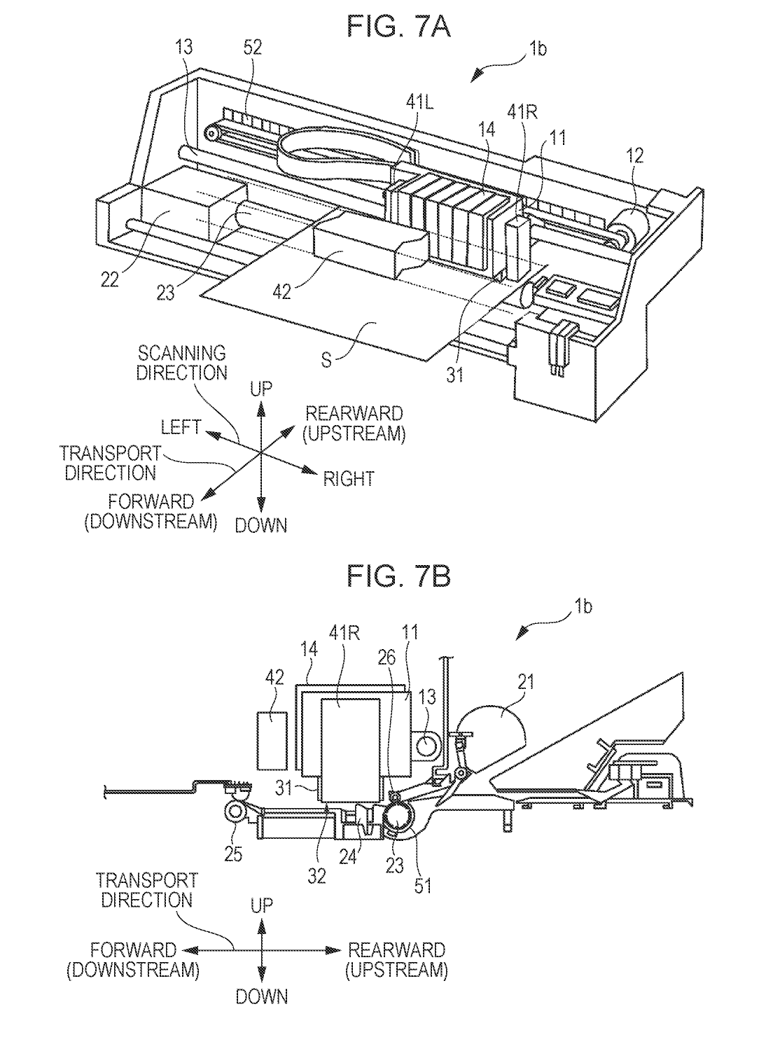

FIG. 6 is a function block diagram of a serial printer 1b (hereinafter, referred to as a printer 1b), and FIGS. 7A and 7B schematically illustrate the entire configuration of the printer 1b. FIG. 7A is a cutaway perspective view of the printer 1b, and FIG. 7B is a transverse cross-sectional view of the printer 1b. The printer 1b illustrated mainly includes, as in the first embodiment, the transporting unit 20, the head unit 30, the UV irradiating mechanism 40, the detector group 50, and the controller 60, and also includes a carriage unit 10.

The carriage unit 10 moves the head 31 in the direction perpendicular to the transport direction (hereinafter, referred to as a scanning direction) and includes a carriage 11 and a carriage motor 12. The carriage 11 is guided by a carriage guide shaft 13 to reciprocate in the scanning direction and is driven by the carriage motor 12. In addition, ink of a plurality of different colors for performing multi-color printing is charged in individual ink cartridges 14. In addition, the ink cartridges 14 corresponding to the ink of the colors are detachably mounted to the carriage 11. Moreover, in the detector group 50, a linear encoder 51 for detecting a position of the carriage 11 in the movement direction is included.

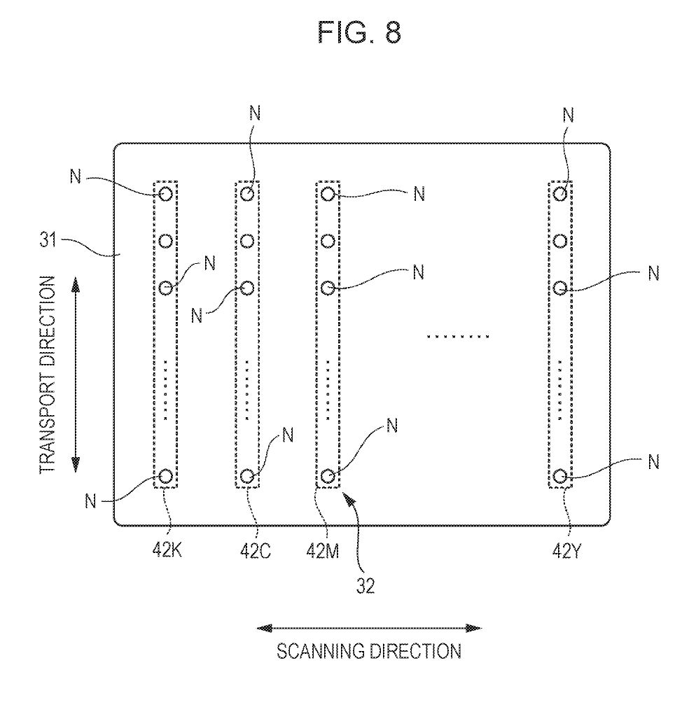

FIG. 8 illustrates an array of nozzles N in the printer 1b according to the second example. In the corresponding embodiment, a plurality of the nozzles N are lined and opened in the lower surface 32 of the head 31 at predetermined intervals in the transport direction, and nozzle rows 33K, 33C, 33M, and 33Y are lined at predetermined intervals along the scanning direction. In addition, the head 31 having the configuration is integrated with the carriage 11 to move in the scanning direction and intermittently discharges ink droplets during the movement thereby forming a dot line (raster line) along the scanning direction on the medium S.

### UV Irradiating Mechanism in Second Example

The printer 1b according to the second embodiment also includes two provisional curing irradiating units 41L and 41R and the main curing irradiating unit 42; however, the two provisional curing irradiating units 41L and 41R are respectively mounted on left and right sides of the carriage 31. In addition, UV light sources are provided on the lower surfaces of the provisional curing irradiating units 41L and 41R, and the provisional curing irradiating units 41L and 41R are moved along with the carriage 11 and irradiate the medium S with UV during the movement.

With regard to the LTV irradiating operation of the provisional curing irradiating units 41L and 41R, for example, UV is irradiated by the provisional curing irradiating unit 41R on the right when the carriage 11 is moved to the left, and UV is irradiated by the provisional curing irradiating unit 41L on the left when the carriage 11 is moved to the right. That is, in the second embodiment, “provisional curing” is performed by irradiating UV ink droplets with low energy UV when the UV ink is discharged from the head 41 during the movement of the carriage 11 and the UV ink droplets are landed on the medium S. In addition, the light sources of the provisional curing irradiating units 41L and 41R have a configuration in which the same number of LEDs as the nozzles N included in the nozzle rows 33K, 33C, 33M, and 33Y are arranged in lines along the transport direction such that the individual nozzles and the individual LEDs are arranged at the same pitches in the transport direction, and at the same time, the arrangement positions thereof are substantially aligned with each other.

### Printing Operations in Second Example

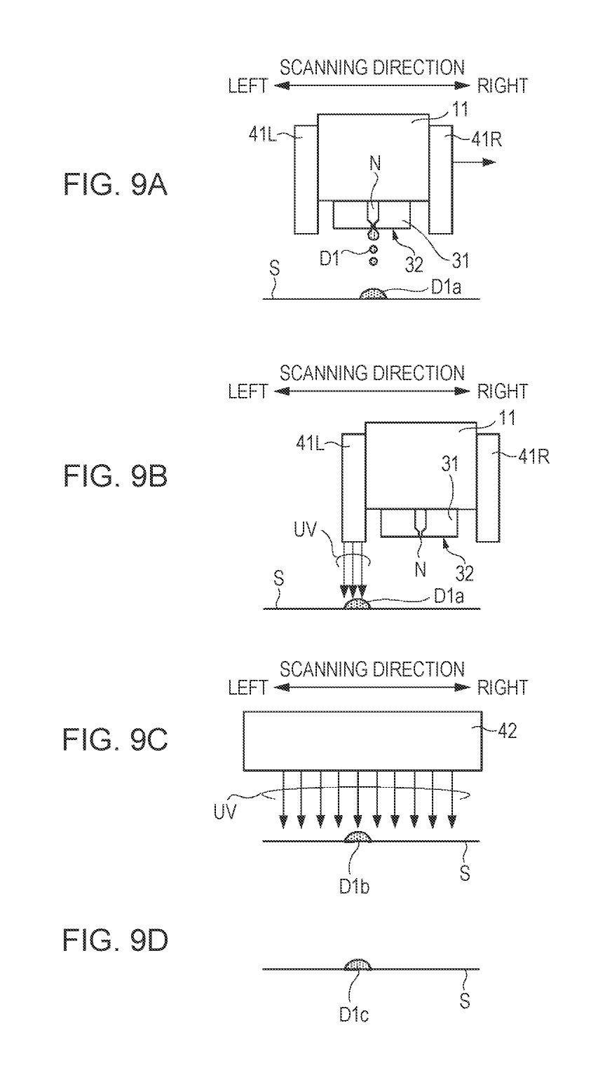

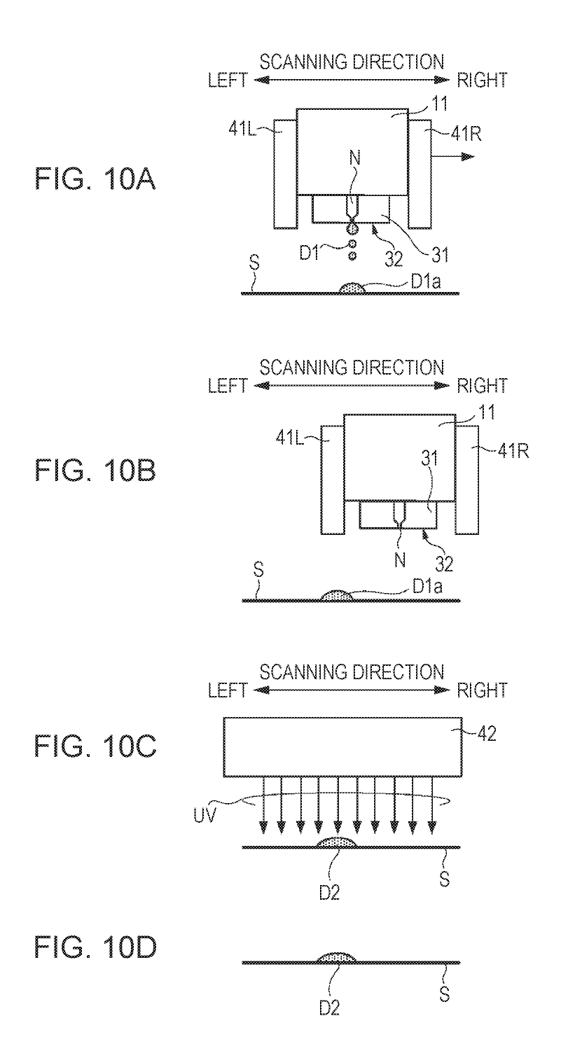

FIGS. 9A to 9D and FIGS. 10A to 10D schematically illustrate printing operations performed in the normal print mode by the printer 1b in the second example and printing operations performed in the inspection print mode, respectively. In the normal print mode, as illustrated in FIGS. 9A to 9D, first, while the head 31 is moved to either of the left and the right in the scanning direction, a liquid droplet D1 of ink of a certain color is discharged from the nozzle N to be landed on the medium S (FIG. 9A). Here, the discharge is made during the movement to the right. In addition, as the head 31 is moved to the further right, the liquid droplet D1 of the ink landed on the medium S is provisionally cured by the provisional curing irradiating unit 41L on the left (FIG. 9B). In addition, the medium S is transported in the downstream direction (in the figure, forward with respect to the sheet surface) so that a liquid droplet D1b of the color ink provisionally cured is irradiated with LTV by the main curing irradiating unit 42 (FIG. 9C). Accordingly, the ink droplet D1b provisionally cured is fixed on the medium S as a dot D1c (FIG. 9D).

On the other hand, in the inspection print mode, first, while the head 31 is moved to either of the left or the right in the scanning direction, a liquid droplet D1 of ink of a certain color is discharged to be landed on the medium S (FIG. 10A). Here, the liquid droplet D1 of the ink is not subjected to the provisional curing (FIG. 10B), and the medium S is transported. Accordingly, an ink droplet D1a slowly flows on the medium S and thus the surface area thereof is increased. In addition, finally, the ink droplet D1a is irradiated with UV by the main curing irradiating unit 42 (FIG. 10C), thereby fixing the corresponding ink droplet D1a as a dot D2 (FIG. 10D).

Moreover, when the dot omission inspection is performed using the inspection image printed by the printer 1b according to the second embodiment, as in the first embodiment, existence of a dot may be optically detected using a scanner or the like. In addition, when it is difficult to detect a liquid droplet of ink having a light color, after the liquid droplet is landed on the medium S, a time for the liquid droplet of the ink to sufficiently flow may be provided. For example, after ink of light colors is initially discharged, as needed, the time to discharge ink of other colors may be lengthened, the transportation of the medium may be suspended, or the time to fully cure the liquid droplet of the ink of light colors landed on the medium S may be lengthened.

### Other Embodiments of Printing Apparatus

In the printer 1a according to the first embodiment, the two heads 31a and 31b have the same array of nozzles N; however, they do not need to have the same array. For example, only nozzles for ink of light colors may be provided in the upstream side head 31a, and only nozzles for ink may with deep colors be provided in the downstream side head 31b. Of course, a single head and a single provisional curing irradiating unit may be provided.

In the embodiments, as the printers 1a and 1b, ink jet printers using a piezo method of applying a voltage to a drive element (piezo element) to expand and contract ink chambers thereby ejecting fluid are exemplified. However, the liquid discharge method is not limited thereto, and a thermal method of generating bubbles in nozzles using heat-generating elements to eject liquid due to the bubbles may be employed.

In addition, a medium to be printed by the printing apparatus is not limited to paper, and any type of medium including fabrics, the label surface of an optical disc (such as a CD-R), and a substrate may be employed as long as ink can be printed thereon. Of course, the medium may be continuously transported like a roll paper or individually transported like a single cut sheet.

The invention can be applied to printing apparatuses for forming an image by discharging a plurality of types of ink to cause liquid droplets of the ink to be landed on a medium, such as, ink jet printers capable of multi-color printing.

What is claimed is:

1. A dot omission inspection method of inspecting for the existence of an omission of a dot, used in a printing apparatus which discharges a photo-curable ink from a nozzle to be landed on a medium as a liquid droplet and irradiates the landed liquid droplets with light to be cured so as to form an image constituted by fine dots on the medium,
wherein the printing apparatus selectively performs, as a process of forming the image, a normal print process of forming an arbitrary image and an inspection print process of forming an inspection image as a detection object for a dot omission,
wherein the normal print process includes:
performing liquid droplet discharge of causing the liquid droplet of the photo-curable ink to be landed on the medium;
performing provisional curing of irradiating the liquid droplet landed on the medium using light from a first light source to provisionally cure the liquid droplet so as to suppress flowing of the liquid droplet; and
performing main curing of irradiating the provisionally cured liquid droplet using light from a second light source to cure the provisionally cured liquid droplet so as to be fixed on the medium, and
wherein, in the inspection print process, the liquid droplet of the photo-curable ink landed on the medium by the liquid droplet discharge is not subjected to the provisional curing and is flowed on the medium so as to increase a surface area of the liquid droplet, and thereafter the main curing is performed.

2. The dot omission inspection method according to claim 1,
wherein various kinds of ink of different colors exist as the ink,
the colors include relatively light colors and relatively deep colors, and
in the inspection print process, with regard to a time to start the main curing after the liquid droplet of the ink is landed on the medium by the liquid droplet discharge, the time for the liquid droplet of the ink of light colors is longer than that of the liquid droplet of the ink of deep colors.

3. A printing apparatus for forming an image by causing a liquid droplet to be landed on a medium, comprising:
a plurality of nozzles for discharging a photo-curable ink as liquid droplets;
a provisional curing irradiating unit;
a main curing irradiating unit; and
a control unit,
wherein the provisional curing irradiating unit irradiates the liquid droplets landed on the medium with light to provisionally cure the liquid droplet to prevent the liquid droplet from flowing,
wherein the main curing irradiating unit irradiates the liquid droplet landed on the medium with light to cure the liquid droplet so as to be fixed on the medium,
wherein the control unit selectively performs a normal print process of forming an arbitrary image and an inspection print process of forming an inspection image as a detection object for a dot omission,
wherein the normal print process includes:
performing liquid droplet discharge of causing the liquid droplet of the photo-curable ink to be landed on the medium;
performing provisional curing of irradiating the liquid droplet landed on the medium using light from the provisional curing irradiating unit to provisionally cure the liquid droplet so as to suppress flowing of the liquid droplet; and
performing main curing of irradiating the provisionally cured liquid droplet using light from the main curing irradiating unit to cure the provisionally cured liquid droplet so as to be fixed on the medium, and
wherein, in the inspection print process, the liquid droplet of the photo-curable ink landed on the medium by the liquid droplet discharge is not subjected to the provisional curing and is flowed on the medium so as to increase a surface area of the liquid droplet, and thereafter the main curing is performed.

4. The printing apparatus according to claim 3, further comprising first and second heads provided with a plurality of the nozzles arranged in a direction perpendicular to a transport direction in which the medium is supplied from an upstream side and the medium is discharged to a downstream side over a width of the medium,
wherein the provisional curing irradiating unit includes a first provisional curing irradiating unit and a second provisional curing irradiating unit,
the nozzles are provided to respectively correspond to the plurality of kinds of the ink including the relatively light colors and deep colors,
the first and second heads, the first and second provisional curing irradiating units, and the main curing irradiating unit are disposed in the order of the first head, the first provisional curing irradiating unit, the second head, the second provisional curing irradiating unit, and the main curing irradiating unit from the upstream side to the downstream side of the transport direction, and
the control unit discharges the ink of light colors from the nozzle of the first head in the inspection print process.
